(19) United States
(12) Patent Application Publication
(10) Pub. No.: US 2019/0010433 A1
(43) Pub. Date: Jan. 10, 2019

(54) METHOD FOR PROVIDING OR PRODUCING ALCOHOLIC BEVERAGE WITH REDUCED ALCOHOLIC TASTE AND ENHANCED AROMATIC SCENT

(71) Applicant: Kirin Kabushiki Kaisha, Nakano-ku, Tokyo (JP)

(72) Inventors: Ai TSUJI, Nakano-ku, Tokyo (JP); Noriko ANO, Nakano-ku, Tokyo (JP); Masako KABESU, Nakano-ku (JP); Koji ONODA, Nakano-ku, Tokyo (JP)

(73) Assignee: Kirin Kabushiki Kaisha, Nakano-ku, Tokyo (JP)

(21) Appl. No.: 16/064,585

(22) PCT Filed: Dec. 22, 2016
(86) PCT No.: PCT/JP2016/005213

§ 371 Date: Jun. 21, 2018

(30) Foreign Application Priority Data
Dec. 25, 2015 (JP) 2015-254194

(51) Int. Cl. C12G 3/08

(52) U.S. Cl. CPC C12G 3/08

(57) ABSTRACT

An object of the present invention is to provide a flavor improving agent for reducing alcoholic feeling and improving aroma development in a specific alcoholic beverage at the time of drinking the specific alcoholic beverage; and a method for providing or producing an alcoholic beverage reduced in alcoholic feeling and improved in aroma development while suppressing effervescence by adding the flavor improving agent in the specific alcoholic beverage at the time of drinking the specific alcoholic beverage, etc.

A flavor improving agent containing a high CO₂-content ice (preferably, carbon dioxide hydrate) having a CO₂ content rate of 3 wt % or more and a size of maximum length of 5 mm or more is used as a flavor improving agent for reducing alcoholic feeling and improving aroma development in the following alcoholic beverage (a) or (b) at the time of drinking the alcoholic beverage:
(a) an alcoholic beverage having an alcohol content of 10% or more;
(b) an alcoholic beverage having an alcohol content of 4% or more and less than 10% and a total nitrogen content of 200 mg/L or less.

### TECHNICAL FIELD

The present invention relates to a flavor improving agent for reducing alcoholic feeling and improving aroma development in (a) an alcoholic beverage having an alcohol content of 10% or more; or (b) an alcoholic beverage having an alcohol content of 4% or more and less than 10% and a total nitrogen content of 200 mg/L or less (hereinafter, the alcoholic beverages (a) and (b) will be collectively referred to also as a “specific alcoholic beverage”) at the time of drinking the specific alcoholic beverage; and a method for providing or producing an alcoholic beverage reduced in alcoholic feeling and improved in aroma development while suppressing effervescence by adding the flavor improving agent in a specific alcoholic beverage at the time of drinking the specific alcoholic beverage, etc.

### BACKGROUND ART

With diversification of consumer's preference, various alcoholic beverages such as wine, shochu (distilled spirit), whisky, liqueur (for example, plum wine) and Japanese sake have been provided. Alcoholic beverages have not only a flavor of alcohol itself but also intrinsic aromas and tastes which vary depending on the types of alcoholic beverages and raw-materials (including a flavoring) used therein, etc. For example, wines have fruity aromas, etc.; rice shochus have brew aromas, etc.; liqueurs have aromas derived from sub ingredients (fruit, herb, seed), etc.; and Japanese sakes have brew aromas of Japanese sake and aromas of aged Japanese sake, etc. The flavor, not the aroma of alcohol (ethanol) itself but the intrinsic aroma of an alcoholic beverage is an important feature characterizing the alcoholic beverage and determining preference to the alcoholic beverage. However, alcoholic beverages are inferior in sweetness and aroma development compared to non-alcoholic beverages. Because of this, techniques for improving aromas of alcoholic beverages, etc., have been proposed. For example, Patent Document 1 proposes a method for enhancing flavor of an alcoholic beverage by using a syrup containing an oil-soluble flavoring. Patent Document 2 proposes a method for enhancing fruit-like flavor and taste, etc., while suppressing the content of a fruit juice by adding a dry pulverized product containing a citrus-derived dietary fiber to an alcoholic beverage containing a fruit juice. However, there are problems such as the method of Patent Document 1 is inferior in versatility because a special syrup is used in the method. The method of Patent Document 2 using a dry pulverized product containing a citrus-derived dietary fiber is also inferior in versatility because it is inferior particularly in versatility to alcoholic beverages except fruit-juice containing alcoholic beverages.

Recently, users tend to prefer low alcoholic beverages than high alcoholic beverages. One of the reasons is alcoholic feeling (ethanol taste). The alcoholic feeling, which is sensed when a person drinks an alcoholic beverage, refers to bitterness of aftertaste and astringent taste derived from alcohol itself in an alcoholic beverage. The strength of alcoholic feeling of an alcoholic beverage tends to keep a person away from drinking of the alcoholic beverage. It is possible to reduce the concentration of an alcohol by, e.g., reducing fermentation time or diluting a solution; however, if so, the intrinsic aroma and taste of an alcoholic beverage itself often deteriorate. Then, a method for reducing alcoholic feeling without changing an alcohol concentration is proposed. For example, Patent Document 3 proposes a method for suppressing alcoholic feeling by adding an extract from fruit skin, a flower or an herb in a high alcoholic beverage in the range of 0.0001 to w/v %, etc. Patent Document 4 proposes a method for suppressing alcoholic feeling by controlling the concentration and acidity of a high intensity sweetener in an alcoholic beverage to fall within the range of a specific ratio, etc. However, it cannot be said that the methods of Patent Document 3 and Patent Document 4 have sufficient versatility to a wide variety of alcoholic beverages, because these methods use a fruit-skin extract, a high intensity sweetener, an acid, etc.

As described above, a method for reducing alcoholic feeling as well as improving aroma development of an intrinsic aroma of an alcoholic beverage and the method applicable in a wide variety of alcoholic beverages, has not yet been known.

In the meantime, a substance called a carbon dioxide hydrate (CO₂ hydrate) is known. The carbon dioxide hydrate refers to a clathrate compound having a carbon dioxide molecule confined in empty spaces of a water-molecule crystal. The water molecule forming a crystal is called a “host molecule”; whereas the molecule confined in empty spaces of the water-molecule crystal is called a “guest molecule” or a “guest substance”. The carbon dioxide hydrate can be produced by placing carbon dioxide and water in the conditions of a low temperature and high carbon dioxide partial pressure, for example, in the conditions where the carbon dioxide partial pressure is higher than the equilibrium pressure of a carbon dioxide hydrate at a given temperature (hereinafter, also referred to as “a carbon dioxide hydrate generation conditions”). The above-mentioned “conditions where the carbon dioxide partial pressure is higher than the equilibrium pressure of a carbon dioxide hydrate” is the conditions specified by a combination of a carbon dioxide pressure and a temperature in the region of in the equilibrium pressure curve of a carbon dioxide hydrate (for example, the vertical axis represents carbon dioxide pressure and the horizontal axis represents temperature) disclosed in FIG. 2 of Non-Patent Document 1 and FIG. 7 and FIG. 15 of Non-Patent Document 2 at the high pressure side (upper side of the equilibrium pressure curve of a carbon dioxide hydrate where, for example, the vertical axis represents carbon dioxide pressure and the horizontal axis represents temperature). Alternatively, the carbon dioxide hydrate can be produced by reacting fine particulate ice, instead of water, and carbon dioxide in the conditions of a low temperature and a low carbon dioxide partial pressure. In producing a carbon dioxide hydrate, as the carbon dioxide pressure increases and the temperature of carbon dioxide and water decreases, the carbon dioxide content rate (CO₂ content rate) in the carbon dioxide hydrate tends to increase. The CO₂ content rate of the carbon dioxide hydrate, which varies depending on the process for producing a carbon dioxide hydrate, can be specified as about 10 to 30 wt %. This content rate is remarkably high compared to the CO₂ content rate of carbonated water (about 0.5 wt %).

As a technique in connection with a carbon dioxide hydrate, for example, Patent Document 5 discloses a method of separating and recovering carbon dioxide contained in a combustion exhaust gas by allowing the combustion exhaust gas in contact with water in pressurized conditions to produce a carbon dioxide hydrate. This is a method of separating and recovering carbon dioxide from a combustion exhaust gas in consideration of global environmental protection, etc. Patent Document 6 discloses a plant cultivation system for use in cultivating a plant within the facility. This system is characterized by having a decomposition means decomposing a carbon dioxide hydrate into carbon dioxide and water; a supply means supplying carbon dioxide decomposed by the decomposition means into the facility; and a heat exchange means exchanging heat between cold, which is generated by decomposing the carbon dioxide hydrate by the decomposition means, with the air in the facility.

Further, there are also examples of using carbon dioxide hydrate in a beverage. For example, Patent Document discloses a method for giving carbonic acid to the beverage by mixing a beverage except a carbonated drink with a carbon dioxide hydrate in a container to produce a carbonated drink. However, Patent Document 7 fails to particularly describe the size of the carbon dioxide hydrate to be added in the beverage, etc., and also fails to disclose adding the carbon dioxide hydrate to an alcoholic beverage, thereby reducing alcoholic feeling of the alcoholic beverage as well as improving aroma development of an intrinsic aroma of the alcoholic beverage, etc. Patent Document 8 discloses adding a sugar-containing carbon dioxide clathrate (a carbon dioxide hydrate) to a beverage, with the result that sweetness and excellent sparkling property of the sugar containing carbon dioxide clathrate act in concert with the intrinsic flavor and texture of the beverage to successfully create flavor and texture never ever present. However, Patent Document 8 fails to describe particularly on the size of the carbon dioxide hydrate to be added in the beverage, etc., and also fails to disclose adding a carbon dioxide hydrate to an alcoholic beverage, thereby reducing alcoholic feeling of the alcoholic beverage as well as improving aroma development of an intrinsic aroma of the alcoholic beverage, etc. Patent Document 9 discloses a method of regenerating a carbonated drink by supplying carbon dioxide into the carbonated drink by adding a carbon dioxide hydrate to a carbonated drink gone flat or bringing a carbon dioxide hydrate into contact with a carbonated drink gone flat. However, Patent Document 9 fails to describe particularly on the size of the carbon dioxide hydrate to be added in the beverage, etc., and also fails to disclose adding a carbon dioxide hydrate to an alcoholic beverage, thereby reducing alcoholic feeling of the alcoholic beverage as well as improving aroma development of an intrinsic aroma of the alcoholic beverage.

As described above, it has not yet been known that a carbon dioxide hydrate or ice with a high CO₂ content rate like a carbon dioxide hydrate is used for reducing alcoholic feeling of the alcoholic beverage as well as improving aroma development of an intrinsic aroma of the alcoholic beverage.

### PRIOR ART DOCUMENT

### Patent Documents

Patent Document 1: Japanese unexamined Patent Application Publication No. 2005-124567
Patent Document 2: Japanese unexamined Patent Application Publication No. 2009-136159
Patent Document 3: Japanese unexamined Patent Application Publication No. 2015-192667
Patent Document 4: Japanese unexamined Patent Application Publication No. 2011-036228
Patent Document 5: Japanese unexamined Patent Application Publication No. 2001-096133
Patent Document 6: Japanese unexamined Patent Application Publication No. 2014-057533
Patent Document 7: Japanese unexamined Patent Application Publication No. 2005-224146
Patent Document 8: Japanese Patent No. 4652367
Patent Document 9: Japanese Patent No. 4969683

### Non-Patent Documents

Non-patent Document 1: “Hydrates of Carbon Dioxide and Methane Mixtures”, J. Chem. Eng. Data (1991) 36, 68-71
Non-patent Document 2: “Phase Equilibrium for Clathrate Hydrates Formed with Methane, Ethane, Propane, or Carbon Dioxide at Temperatures below the Freezing Point of Water”, J. Chem. Eng. Data (2008), 53, 2182-2188

### SUMMARY OF THE INVENTION

### Object to be Solved by the Invention

An object of the present invention is to provide a flavor improving agent for reducing alcoholic feeling and improving aroma development in a specific alcoholic beverage at the time of drinking the specific alcoholic beverage; and a method for providing or producing an alcoholic beverage reduced in alcoholic feeling and improved in aroma development while suppressing effervescence by adding the flavor improving agent in the specific alcoholic beverage at the time of drinking the specific alcoholic beverage, etc.

### Means to Solve the Object

The present inventors conducted intensive studies to solve the above-mentioned object. During the studies, they found that if ice having a CO₂ content rate of 3 wt % or more and a size of maximum length of 5 mm or more (preferably, carbon dioxide hydrate) is added in a specific alcoholic beverage at the time of drinking of the specific alcoholic beverage, alcoholic feeling can be reduced and aroma development of an intrinsic aroma of the specific alcoholic beverage can be improved while suppressing effervescence in the alcoholic beverage. Based on the finding, the present invention was accomplished.

More specifically, the present invention relates to

(1) A flavor improving agent for reducing alcoholic feeling and improving aroma development in the following alcoholic beverage (a) or (b) at the time of drinking the alcoholic beverage, wherein the flavor improving agent comprises ice having a CO₂ content rate of 3 wt % or more and a size of maximum length of 5 mm or more:

(a) an alcoholic beverage having an alcohol content of 10% or more;

(b) an alcoholic beverage having an alcohol content of 4% or more and less than 10% and a total nitrogen content of 200 mg/L or less.

(2) The flavor improving agent according to the above item (1), wherein the ice having a CO₂ content rate of 3 wt % or more is a carbon dioxide hydrate; and

(3) The flavor improving agent according to the above item (1) or (2), wherein the alcoholic beverage is selected from the group consisting of fruit liquors, distilled liquors, liqueurs and Japanese sake.

The present invention also relates to

(4) A method for producing an alcoholic beverage having reduced alcoholic feeling and improved aroma development, and suppressed effervescence, comprising adding the flavor improving agent according to any one of the above items (1) to (3) in the following alcoholic beverage (a) or (b) at the time of drinking the alcoholic beverage, thereby reducing alcoholic feeling and improving aroma development while suppressing effervescence in the alcoholic beverage:

(a) an alcoholic beverage having an alcohol content of 10% or more;

(b) an alcoholic beverage having an alcohol content of 4% or more and less than 10% and a total nitrogen content of 200 mg/L or less;

(5) The method for producing an alcoholic beverage according to the above item (4), wherein the amount of the flavor improving agent to be added in the alcoholic beverage is within the range of 0.02 to 4.0 g/mL in terms of ice having a CO₂ content rate of 3 wt % or more or in terms of a carbon dioxide hydrate; and

(6) The method for producing an alcoholic beverage according to the above item (4) or (5), wherein the alcoholic beverage is selected from the group consisting of fruit liquors, distilled liquors, liqueurs and Japanese sake.

### Effect of the Invention

According to the present invention, a flavor improving agent for reducing alcoholic feeling and improving aroma development in a specific alcoholic beverage at the time of drinking the specific alcoholic beverage; and a method for providing or producing an alcoholic beverage reduced in alcoholic feeling and improved in aroma development while suppressing effervescence by adding the flavor improving agent to a specific alcoholic beverage at the time of drinking the specific alcoholic beverage, etc., can be provided.

### MODE OF CARRYING OUT THE INVENTION

The present invention consists of a flavor improving agent for reducing alcoholic feeling and improving aroma development in a specific alcoholic beverage at the time of drinking the specific alcoholic beverage (hereinafter, also referred to as “flavor improving agent of the present invention”); and a method for providing or producing an alcoholic beverage reduced in alcoholic feeling and improved in aroma development while suppressing effervescence by adding the flavor improving agent of the present invention in a specific alcoholic beverage at the time of drinking the specific alcoholic beverage (hereinafter, also referred to as a “method for providing or producing the alcoholic beverage of the present invention”), etc. Note that, in the present specification, the flavor improving agent of the present invention can be also referred to as the flavor improving composition of the present invention or the flavor improving substance of the present invention.

1. <Flavor Improving Agent of the Present Invention>

The flavor improving agent of the present invention is a flavor improving agent for reducing alcoholic feeling and improving aroma development in the following alcoholic beverage (a) or (b) (a specific alcoholic beverage) at the time of drinking the specific alcoholic beverage.

(a) an alcoholic beverage having an alcohol content of 10% or more;

(b) an alcoholic beverage having an alcohol content of 4% or more and less than 10% and a total nitrogen content of 200 mg/L or less.

The flavor improving agent of the present invention is not particularly limited as long as it contains ice having a CO₂ content rate of 3 wt % or more and a size of maximum length of 5 mm or more (hereinafter, also referred to as “high-CO₂ content ice to be used in the present invention”). If the high-CO₂ content ice is added in a specific alcoholic beverage, it is possible to reduce alcoholic feeling and improve aroma development while suppressing effervescence in a specific alcoholic beverage.

(Ice Having a CO₂ Content Rate of 3 wt % or More and a Size of Maximum Length of 5 mm or More)

The high-CO₂ content ice to be used in the present invention is not particularly limited in shape and number etc., as long as it has a size of maximum length of 5 mm or more and a CO₂ content rate of 3 wt % or more. The high-CO₂ content ice may be a high-CO₂ content ice which is not a carbon dioxide hydrate; however, it is preferably a carbon dioxide hydrate from the viewpoint of obtaining superior effects in reducing alcoholic feeling and improving aroma development. A carbon dioxide hydrate is a solid clathrate compound having a carbon dioxide molecule confined in empty spaces of a water-molecule crystal. A carbon dioxide hydrate is usually present in the state of a glacial crystal and releases carbon dioxide while melting if it is placed, for example, in the temperature condition at which ice melts at normal atmospheric pressure. As the high-CO₂ content ice in the present invention, a high-CO₂ content ice which is not a carbon dioxide hydrate may be used alone; a carbon dioxide hydrate may be used alone; or a high-CO₂ content ice which is not a carbon dioxide hydrate may be used in combination with a carbon dioxide hydrate.

The shape of the high-CO₂ content ice to be used in the present invention (preferably, carbon dioxide hydrate) may be a substantially polyhedral shape such as substantially spherical shape; substantially ellipsoidal shape; substantially cuboid shape; or these shapes further having unevenness. Examples of the high-CO₂ content ice to be used in the present invention (preferably, carbon dioxide hydrate) also include crushed ice pieces (block) having various shapes obtained by arbitrarily crushing a block of high-CO₂ content ice (preferably, carbon dioxide hydrate) as long as they have a size of maximum length of 5 mm or more.

As for the size of the high-CO₂ content ice to be used in the present invention (preferably, carbon dioxide hydrate), an ice having a maximum length of 5 mm or more can be used, as previously mentioned. From the viewpoint of balance among suppression of effervescence generated when the ice is put in an alcoholic beverage, reduction of alcoholic feeling and improvement of aroma development, an ice having a maximum length of preferably 5 mm or more and 100 mm or less, more preferably 5 mm or more and 80 mm or less and further preferably 5 mm or more and 60 mm or less can be exemplified. If the maximum length of the high-CO₂ content ice (preferably, carbon dioxide hydrate) is less than 5 mm, effervescence cannot be sometimes suppressed when the ice is added in an alcoholic beverage, aroma development of an intrinsic aroma of the alcoholic beverage is not substantially improved and only aroma of carbon dioxide gas is improved. Because of this, in the present invention, the high-CO₂ content ice (preferably, carbon dioxide hydrate) having a size of maximum length of 5 mm or more is used. The maximum length of the high-CO₂ content ice which is not a carbon dioxide hydrate can be adjusted by adjusting the maximum length of a mold for producing the high-CO₂ content ice or the degree of crushing when crushing the high-CO₂ content ice product. The maximum length of a carbon dioxide hydrate can be adjusted by adjusting the maximum length of a mold to be used in compression molding of the carbon dioxide hydrate or the degree of crushing when crushing the carbon dioxide hydrate produced by compression molding.

The carbon dioxide content rate (CO₂ content rate) in the high-CO₂ content ice to be used in the present invention (preferably, carbon dioxide hydrate) is not particularly limited as long as the content is 3 wt % or more, and is preferably 5 wt % or more, more preferably 7 wt % or more, further preferably 10 wt % or more and still more preferably 12 wt % or more. The upper limit thereof is not particularly limited, and 30 wt %, 20 wt % and 18 wt % can be exemplified. The CO₂ content rate of a carbon dioxide hydrate can be adjusted by “the high level or low level of carbon dioxide partial pressure”, “the degree of dehydration treatment”, “whether or not a compression molding process is to be applied” and/or “the degree of the pressure in compression molding process”, etc. For example, the CO₂ content rate of a carbon dioxide hydrate can be increased by “increasing the carbon dioxide partial pressure”, “raising the degree of dehydration treatment”, “applying compression molding process” and “increasing the pressure in the compression molding process” in producing a carbon dioxide hydrate. Note that, when the high-CO₂ content ice such as a carbon dioxide hydrate melts, carbon dioxide contained in the high-CO₂ content ice is released and the weight decreases by the weight of the released carbon dioxide. Thus, the CO₂ content rate of the high-CO₂ content ice is calculated based on, for example, the weight change when the high-CO₂ content ice is melted at normal temperature, in accordance with the following formula:

(CO₂ content rate)=(sample weight before melt−sample weight after melt)/(sample weight before melt)

In the present invention, in the case where two or more high-CO₂ content ices (preferably, carbon dioxide hydrate) are used, these high-CO₂ content ices (preferably, carbon dioxide hydrate) may have the same or substantially the same shapes and/or sizes or may have different shapes and/or sizes. The phrase “substantially the same size” herein means that, assuming that the maximum length of the high-CO₂ content ice (preferably, carbon dioxide hydrate) having the longest maximum length is 100, the maximum length of the other high-CO₂ content ice (preferably, carbon dioxide hydrate) falls within the range of 80 to 100 (preferably, 90 to 100).

In the present specification, the “maximum length” means the length of the longest line of the lines which connect two points on the surface of a block of a high-CO₂ content ice (preferably, carbon dioxide hydrate), and pass the gravity center of the block.

As for the size of the high-CO₂ content ice to be used in the present invention (preferably, carbon dioxide hydrate), an ice having a maximum length of 5 mm or more can be used, as previously mentioned. As a preferable embodiment thereof, high-CO₂ content ice having an aspect ratio (maximum length/minimum length) preferably within the range of 1 to 5, more preferably within the range of 1 to 4, further preferable within the range of 1 to 3, can be exemplified. Note that, in the present specification, “minimum length” means the length of the shortest line of the lines which connect two points on the surface of a block of a high-CO₂ content ice (preferably, carbon dioxide hydrate), and pass the gravity center of the block. Such maximum length and minimum length can be measured not only by a commercially available particle size distribution measuring device based on image analysis but also by allowing a ruler in contact with the block of the high-CO₂ content ice (preferably, carbon dioxide hydrate).

It is preferable that all of the high-CO₂ content ice (preferably, carbon dioxide hydrate) contained in the flavor improving agent of the present invention have a size of maximum length of 5 mm or more; however, high-CO₂ content ice (preferably, carbon dioxide hydrate) having a maximum length of less than 5 mm may be contained as long as the effect of the present invention can be obtained. Of the high-CO₂ content ice (preferably, carbon dioxide hydrate) contained in the flavor improving agent of the present invention, high-CO₂ content ice (preferably, carbon dioxide hydrate) having a maximum length of less than 5 mm are preferably contained in a ratio (wt %) of 10 wt % or less, preferably 5 wt % or less, more preferably 3 wt % or less and further preferably 1 wt % or less. It is preferable that the high-CO₂ content ice (preferably, carbon dioxide hydrate) contained in the flavor improving agent of the present invention all have a CO₂ content rate of 3 wt % or more; however, ice or carbon dioxide hydrate having a CO₂ content rate of less than 3 wt % may be contained as long as the effect of the present invention can be obtained. The ratio (wt %) of ice or carbon dioxide hydrate having a CO₂ content rate of less than 3 wt % is 10 wt % or less, preferably 5 wt % or less, more preferably 3 wt % or less and further preferably 1 wt % or less of the high-CO₂ content ice (preferably, carbon dioxide hydrate) contained in the flavor improving agent of the present invention.

A method for producing the high-CO₂ content ice in the present invention is not particularly limited as long as ice having a CO₂ content rate of 3 wt % or more can be produced. As the method for producing a high-CO₂ content ice except a carbon dioxide hydrate, a method of freezing raw-material water while blowing CO₂ into the raw-material water in the conditions, which do not satisfy the conditions for generating a carbon dioxide hydrate, is mentioned. The method for producing a carbon dioxide hydrate to be used in the present invention is not particularly limited as long as a carbon dioxide hydrate can be produced. Conventional methods can be used, which include a gas/liquid stirring method where raw-material water is stirred while blowing carbon dioxide into the raw-material water in the conditions satisfying the conditions for generating carbon dioxide hydrate; and a water spray method where raw-material water is sprayed into carbon dioxide in the conditions satisfying the conditions for generating carbon dioxide hydrate. The carbon dioxide hydrate generated by these methods is usually obtained in a slurry state where the carbon dioxide hydrate fine particles are mixed with unreacted water. In order to increase the concentration of the carbon dioxide hydrate, it is preferable to apply a dehydration treatment to the carbon dioxide hydrate. The carbon dioxide hydrate (more specifically, relatively high-concentration carbon dioxide hydrate) relatively reduced in moisture content by the dehydration treatment is preferably compression molded into a predetermined shape (for example, spherical, cuboid) by a pellet forming machine. The compression molded carbon dioxide hydrate may be directly used in the present invention or may be crushed, if necessary, and put in use. Note that, as a method for producing a carbon dioxide hydrate, a method of using raw-material water is relatively widely used, as previously mentioned; however, a method of producing a carbon dioxide hydrate by reacting fine particulate ice (raw-material ice) used instead of water (raw-material water) with carbon dioxide in the conditions of a low temperature and low carbon dioxide partial pressure, can be used.

The above-mentioned “conditions for generating a carbon dioxide hydrate” refer to the conditions where the partial pressure of carbon dioxide (carbon dioxide pressure) is higher than the equilibrium pressure of a carbon dioxide hydrate at a given temperature, as previously mentioned. The above-mentioned “conditions where the partial pressure of carbon dioxide is higher than the equilibrium pressure of a carbon dioxide hydrate” refers to the conditions expressed by a combination of a carbon dioxide pressure and a temperature in the equilibrium pressure curve of a carbon dioxide hydrate (for example, the vertical axis represents carbon dioxide pressure, the horizontal axis represents temperature) disclosed in FIG. 2 of Non-Patent Document 1 (J. Chem. Eng. Data (1991) 36, 68-71) and FIG. 7 And FIG. 15 of Non Patent Document 2 (J. Chem. Eng. Data (2008), 53, 2182-2188); more specifically, in the region at the high pressure side of the curve (the vertical axis represents, for example, carbon dioxide pressure and the horizontal axis represents temperature); in other words, the region above the equilibrium pressure curve of a carbon dioxide hydrate (the vertical axis represents, for example, carbon dioxide pressure and the horizontal axis represents temperature). As the carbon dioxide hydrate generation conditions, for example, the conditions defined by a combination of a temperature “within the range of −3 to 4° C.” and “a carbon dioxide pressure within the range of 1.8 to 3.2 MPa, are mentioned.

In the flavor improving agent of the present invention, the content of the high-CO₂ content ice (preferably, carbon dioxide hydrate), which is not particularly limited, may fall within the range of, for example, 5 to 100 wt %, preferably 30 to 100 wt %, more preferably 50 to 100 wt % and further preferably 70 to 100 wt %.

In the flavor improving agent of the present invention, the high-CO₂ content ice (preferably, carbon dioxide hydrate) may be high-CO₂ content ice (preferably, carbon dioxide hydrate) consisting of carbon dioxide and ice alone (hereinafter, also referred to the “high-CO₂ content ice (preferably, carbon dioxide hydrate) containing no optional components”) or may be high-CO₂ content ice (preferably, carbon dioxide hydrate) further containing optional components such as a sweetener and a pigment. The flavor improving agent of the present invention may be a flavor improving agent consisting of only “high-CO₂ content ice containing no optional components (preferably, carbon dioxide hydrate)” or “high-CO₂ content ice containing optional components (preferably, carbon dioxide hydrate)” and may further contain optional components except the high-CO₂ content ice (preferably, carbon dioxide hydrate). Examples of the optional components except the high-CO₂ content ice (preferably, carbon dioxide hydrate) include a sweetener, a pigment, a salt and a thickener.

In the present specification, the “sweetener” refers to a component exhibiting sweetness. Examples of the sweetener include non-centrifugal sugars such as unrefined sugar, white sugar, casonade (brown sugar), Wasanbon, sorghum sugar and maple sugar; purified sugars such as coarse sugar (e.g., white coarse sugar, yellow coarse sugar, granulated sugar), refined sugar (e.g., superfine sugar, soft brown sugar), processed sugar (e.g., cube sugar, rock sugar, powdered sugar, granular sugar) and liquid sugar; sugar sweeteners such as a monosaccharide (e.g., glucose, fructose, wood sugar, sorbose, galactose, isomerized sugar), a disaccharide (e.g., sucrose, maltose, lactose, isomerized lactose, palatinose), an oligosaccharide (e.g., fructo-oligosaccharide, malto-oligosaccharide, isomalto-oligosaccharide, galacto-oligosaccharide, coupling sugar) and a sugar alcohol (erythritol, sorbitol, xylitol, mannitol, maltitol, isomaltitol, lactitol, maltotriitol, isomaltotriitol, panitol, oligosaccharide alcohol and starch syrup of powdered reduced malt sugar); and high intensity sweeteners such as natural non sugar sweetener (e.g., stevia extract, licorice extract) and synthetic non sugar sweetener (e.g., aspartame, acesulfame K).

Examples of the above-mentioned “pigment” include, but are not particularly limited to, a carotenoid pigment such as marigold pigment, a flavonoid pigment such as a safflower pigment, an anthocyanin pigment, gardenia pigment, a betanin pigment such as beet pigment, chlorella, chlorophyll and a caramel pigment.

Depending on the process, etc., the carbon dioxide hydrate excellent in storability and stability can be obtained. Accordingly, the flavor improving agent of the present invention may be stored at normal temperature (5 to 35° C.) and normal pressure during distribution and storage; however, from the viewpoint of storing the flavor improving agent of the present invention for a longer term and more stably, the flavor improving agent of the present invention is preferably stored “in low temperature conditions”, “in high pressure conditions” or “in low temperature/high pressure conditions” during distribution and storage, etc. Of them, storage “in low temperature conditions” is preferable in view of convenience for storage, and storage “in low temperature conditions” at normal pressure is more preferable.

Examples of the upper limit temperature in the above-mentioned “low temperature conditions” include 10° C. or less, preferably 5° C. or less, more preferably 0° C. or less, further preferably −5° C. or less, more preferably −10° C. or less, further preferably −15° C. or less, more preferably −20° C. and further preferably −25° C. Examples of the lower limit temperature in the above-mentioned “low temperature conditions” include −273° C. or more, −80° C. or more, −50° C. or more, −40° C. or more or −30° C. or more, etc.

Examples of the lower limit pressure in the above-mentioned “high pressure conditions” include 1050 hectopascal (hPa) or more, preferably 1150 hPa or more, more preferably 1300 hPa or more and further preferably 1500 hPa or more. Examples of the upper limit pressure in the above-mentioned “high pressure conditions” include 15000 hPa or less, 12000 hPa or less, 10000 hPa or less, 8000 hPa or less or 5000 hPa or less, etc.

The target beverage by the flavor improving agent of the present invention for reducing alcoholic feeling and improving aroma development is the following alcoholic beverage (a) or (b), as previously mentioned.

(a) an alcoholic beverage having an alcohol content of 10% or more;

(b) an alcoholic beverage having an alcohol content of 4% or more and less than 10% and a total nitrogen content of 200 mg/L or less.

The above-mentioned alcoholic beverage (a) is not particularly limited as long as it is an alcoholic beverage having an alcohol content of 10% or more; however, from the viewpoint to more sufficiently suppress effervescence when the flavor improving agent of the present invention is added in the alcoholic beverage, in particular, an alcoholic beverage having an “alcohol content of 10% or more” and a “total nitrogen content of 2000 mg/L or less, preferably 1500 mg/L or less, more preferably 1000 mg/L or less, and further preferably 800 mg/L or less”, can be exemplified. The total nitrogen content in the beverage is an index of a protein concentration in the beverage, and is an index of the concentration of a substance being the factor of making bubbles. Further, the total polyphenol concentration in the beverage is an index of the concentration of a substance being the factor of making bubbles. Thus, as a preferable embodiment of the above-mentioned alcoholic beverage (a) from the viewpoint to more sufficiently suppress effervescence when the flavor improving agent of the present invention is added in the alcoholic beverage, an alcoholic beverage having an “alcohol content of 10% or more” and “which sum of the total nitrogen content (mg/L) and the total polyphenol content (mg/L) is 2700 mg/L or less, preferably 2400 mg/L or less, more preferably 2100 mg/L or less” can be exemplified. Of them, an alcoholic beverage having an “alcohol content of 10% or more” and “which sum of the total nitrogen content (mg/L) and the total polyphenol content (mg/L) is 2700 mg/L or less, preferably 2400 mg/L or less and more preferably 2100 mg/L or less” and “which total nitrogen content (mg/L) is 500 mg/L or less, preferably 350 mg/L or less and more preferably 200 mg/L or less” can be preferably exemplified.

The above-mentioned alcoholic beverage (b) is not particularly limited as long as it is an alcoholic beverage having an “alcohol content of 4% or more and less than 10%” and “which total nitrogen content is 200 mg/L or less”; however, from the viewpoint to more sufficiently suppress effervescence when the flavor improving agent of the present invention is added in the alcoholic beverage, in particular, an alcoholic beverage having an “alcohol content of 4% or more and less than 10%” and “which total nitrogen content is less than 200 mg/L, preferably 180 mg/L or less, more preferably 150 mg/L or less, further preferably 120 mg/L or less, more preferably 100 mg/L or less and further preferably 80 mg/L or less”, can be preferably exemplified.

In a specific alcoholic beverage which is the subject of the flavor improving agent of the present invention, the alcohol content (%), total nitrogen content (mg/L) and total polyphenol content (mg/L) all means the concentrations in the specific alcoholic beverage before the flavor improving agent of the present invention is added.

In the present specification, the “alcohol content” refers to the content (v/v %) of alcoholic ingredients in an alcoholic beverage. The alcohol content can be measured by any one of the methods known in the art, for example, a vibration densitometer. Specific examples will be described below. A beverage is filtered or sonicated, to prepare a sample from which carbon dioxide gas is removed. The sample is distilled by direct fire to obtain a distillate. The density of the distillate at 15° C. is measured. The measured value converted in accordance with “Table 2: Conversion Table of Alcohol content, Density (15° C.) and Specific Gravity (15/15° C.)” attached to the Official Analysis Method of the National Tax Agency (Instruction No. 6 from the National Tax Agency, 2007, revised on Jun. 22, 2007). In this way, the alcohol content in the beverage can be obtained. Also the total nitrogen content and total polyphenol content in an alcoholic beverage can be measured by conventional methods. The total nitrogen content can be measured, for example, by a combustion method (see, an attachment to “Food Labeling Act”, i.e., “Analysis Method for Nutritional Components”). The total polyphenol content can be measured, for example, by the Folin-Denis method using a calibration curve prepared by chlorogenic acid.

Specific examples of the above-mentioned alcoholic beverage (a) or (b) include a fruit liquor, a distilled liquor, a liqueur, Japanese sake, etc. Examples of the above-mentioned fruit liquor include a wine (fruit wine) such as grape wine (wine) and apple wine (cider); and a sweet fruit liquor such as sherry and port. Of them, wine is preferable and, in particular, a grape wine is more preferable. Of them, white wine and rose wine are more preferable. Examples of the above-mentioned distilled liquor include shochu, whisky, vodka and spirit. Examples of the above-mentioned liqueur include plum wine, cassis liqueur, orange liqueur, lemon liqueur, grapefruit liqueur, lime liqueur, apricot liqueur, strawberry liqueur and yogurt liqueur. Examples of the Japanese sake include daiginjo-shu (very special brew), junmai daiginjo-shu (pure rice, very special brew), ginjo-shu (special brew), junmai ginjo-shu (pure rice, special brew), hon-jouzo shu (genuine brew) and junmai-shu (pure rice).

The method for using the flavor improving agent of the present invention will be described in detail, in the sections of “method for providing or producing the alcoholic beverage of the present invention” and “method for reducing alcoholic feeling and improving aroma development while suppressing effervescence in the alcoholic beverage of the present invention” in the following; however, it is not particularly limited as long as it comprises a step of adding the flavor improving agent of the present invention in a specific alcoholic beverage at the time of drinking the specific alcoholic beverage. Those skilled in the art, who refer to the present specification, can adjust the used amount of the flavor improving agent of the present invention, in accordance with the content of the high-CO₂ content ice (preferably, carbon dioxide hydrate) in the flavor improving agent of the present invention, the CO₂ content rate in the high-CO₂ content ice (preferably, carbon dioxide hydrate), the degree of easiness of effervescence of a specific alcoholic beverage (e.g., low level of alcohol content, high level of total nitrogen content) and tolerance of a beverage container containing the specific alcoholic beverage to bubbles generated by addition of the high-CO₂ content ice (preferably, carbon dioxide hydrate).

2. <Method for Providing or Producing the Alcoholic Beverage of the Present Invention>

The method for providing or producing the alcoholic beverage of the present invention is a method for providing or producing alcoholic beverage reduced in alcoholic feeling and improved in aroma development while suppressing effervescence. The method for providing or producing the alcoholic beverage of the present invention is not particularly limited as long as it comprises a step of adding the flavor improving agent of the present invention in a specific alcoholic beverage (the above-mentioned alcoholic beverage (a) or (b)) at the time of drinking the specific alcoholic beverage. By adding the flavor improving agent of the present invention in a specific alcoholic beverage at the time of drinking the specific alcoholic beverage, alcoholic feeling can be reduced and aroma development can be improved while suppressing effervescence in the alcoholic beverage.

As a preferable embodiment of the method for producing an alcoholic beverage according to the present invention, a method for producing an alcoholic beverage reduced in alcoholic feeling and improved in aroma development while suppressing effervescence, comprising the following steps A to C, can be exemplified.

(A) Step A of preparing the following alcoholic beverage (a) or (b):

(a) an alcoholic beverage having an alcohol content of 10% or more;

(b) an alcoholic beverage having an alcohol content of 4% or more and less than 10% and a total nitrogen content of 200 mg/L or less.

(B) Step B of preparing a flavor improving agent containing ice (preferably, carbon dioxide hydrate) having a CO₂ content rate of 3 wt % or more and a size of maximum length of 5 mm or more;

(C) Step C of adding the flavor improving agent of Step B in the alcoholic beverage prepared in Step A at the time of drinking the alcoholic beverage.

In the present specification, “adding the flavor improving agent of the present invention in a specific alcoholic beverage (or the alcoholic beverage prepared in Step A) at the time of drinking the specific alcoholic beverage” means adding the flavor improving agent of the present invention during the time period before and after the specific alcoholic beverage is provided to a person who drinks it (user). The time period is, for example, the time period between 7 minutes before to 7 minutes after the alcoholic beverage is provided to a user; preferably, the time period between 5 minutes before to 5 minutes after the alcoholic beverage is provided to a user; more preferably the time period between 3 minutes before to 3 minutes after the alcoholic beverage is provided to a user; and further preferably the time period between one minute before to one minute after the alcoholic beverage is provided to a user. “Adding the flavor improving agent of the present invention in the specific alcoholic beverage at the time of drinking the specific alcoholic beverage” include the case in which the person who provides or drinks the alcoholic beverage adds the flavor improving agent of the present invention in the alcoholic beverage; in particular, an embodiment in which the person who provides or drinks the alcoholic beverage adds the flavor improving agent of the present invention in the alcoholic beverage at a site where the person who drinks the specific alcoholic beverage can visually confirm the addition operation. Note that the “specific alcoholic beverage” to which the flavor improving agent of the present invention is to be added, is preferably contained in a beverage container that is not sealed, such that the flavor improving agent of the present invention can be added.

In the present specification, “adding the flavor improving agent of the present invention in a specific alcoholic beverage” includes not only the case of adding the flavor improving agent of the present invention in a specific alcoholic beverage, but also the case where the specific alcoholic beverage is added in the flavor improving agent of the present invention as long as the specific alcoholic beverage can be brought into contact with the flavor improving agent of the present invention, etc. for convenience sake; however, from the viewpoint of balance between suppression of effervescence generated at the time of adding the flavor improving agent in the alcoholic beverage, reduction of alcoholic feeling and improvement of aroma development, the case in which the flavor improving agent of the present invention is added in a specific alcoholic beverage is preferably included.

When the specific alcoholic beverage is, for example, an alcoholic beverage prepared by mixing 2 or more types of liquids, such as highball (whisky soda) comprising carbonated water and whisky, “adding the flavor improving agent of the present invention in a specific alcoholic beverage” in the present specification includes not only adding the flavor improving agent of the present invention in an alcoholic beverage prepared by mixing 2 or more types of liquids, but also adding the flavor improving agent of the present invention in at least one type of the liquids among the 2 or more types of liquids, and then adding the remaining types of liquids; however, from the viewpoint of balance between the suppression of effervescence generated at the time of adding the flavor improving agent in the alcoholic beverage, reduction of alcoholic feeling and improvement of aroma development, a case where the flavor improving agent of the present invention is added in an alcoholic beverage prepared by mixing two or more types of liquids is preferably included. Note that, in a case where the specific alcoholic beverage contains carbonated water, it is preferable to add the flavor improving agent of the present invention in the alcoholic beverage after the bubbles generated by the addition of carbonated water in a beverage container calms down.

The liquid temperature of a specific alcoholic beverage when the flavor improving agent of the present invention is added, is not particularly limited, and may fall within the range of 15 to 35°, 0 to 15° C., 0 to 10° C. or 0 to 7° C. Lower is the liquid temperature of the alcoholic beverage, lower tends to be the expansion rate of the alcoholic beverage at the time of adding the flavor improving agent.

The amount of the flavor improving agent of the present invention added in a specific alcoholic beverage is not particularly limited as long as it can reduce alcoholic feeling and improve aroma development while suppressing effervescence in the alcoholic beverage. Those skilled in the art who refer to the present specification can adjust the amount of the flavor improving agent of the present invention added, in accordance with the content of the high-CO₂ content ice (preferably, carbon dioxide hydrate) in the flavor improving agent of the present invention, the CO₂ content rate in the high-CO₂ content ice (preferably, carbon dioxide hydrate), the degree of easiness of effervescence of a specific alcoholic beverage (e.g., low level of alcohol content, high level of total nitrogen content) and tolerance of a beverage container containing a specific alcoholic beverage to bubbles generated by addition of the high-CO₂ content ice (preferably, carbon dioxide hydrate). Conversely, the liquid level of the alcoholic beverage in a beverage container can be adjusted to a height so that the beverage or bubbles do not spill over from the beverage container even when a specific amount of the flavor improving agent of the present invention is added in the specific alcoholic beverage.

Specific examples of the amount of the flavor improving agent of the present invention added in a specific alcoholic beverage, for example, include the range of 0.02 to 4.0 g/mL, preferably 0.05 to 1.0 g/mL, and more preferably 0.1 to 1.2 g/mL in terms of a carbon dioxide hydrate. Examples of the further preferable amount of the flavor improving agent of the present invention added depending on the type of specific alcoholic beverage include, for example, in the case of whisky, the range of 0.02 to 4.0 g/mL; in the case of shochu, plum wine and spirits sparkling (1) the range of 0.02 to 3.0 g/mL; and in the case of white wine, the range of 0.02 to 0.4 g/mL. Note that, these preferable ranges of the added amount are particularly preferably used in the case where the CO₂ content rate of a carbon dioxide hydrate falls within the range of 10 to 20 wt % and preferably within the range of 15 to 20 wt %.

The above-mentioned Step A in the preferable method for producing the alcoholic beverage of the present invention is not particularly limited as long as the following alcoholic beverage (a) or (b) is prepared.

(a) an alcoholic beverage having an alcohol content of 10% or more;

(b) an alcoholic beverage having an alcohol content of 4% or more and less than 10% and a total nitrogen content of 200 mg/L or less.

As a method for preparing such a specific alcoholic beverage, a method of preparing a commercially available alcoholic beverage corresponding to the above-mentioned (a) or (b), and a method of preparing an alcoholic beverage corresponding to the above-mentioned (a) or (b) by, for example, a production method known in the art, are mentioned. In view of convenience, it is preferable to use a method of preparing a commercially available alcoholic beverage corresponding to the above-mentioned (a) or (b).

The above-mentioned Step B in the preferable method for producing the alcoholic beverage of the present invention is not particularly limited as long as it is a step of preparing a flavor improving agent containing ice (preferably, carbon dioxide hydrate) having a CO₂ content rate of 3 wt % or more and a size of maximum length of 5 mm or more. As the method for preparing such a flavor improving agent, for example, a method of preparing ice (preferably, carbon dioxide hydrate) by producing ice (preferably, carbon dioxide hydrate) having a CO₂ content rate of 3 wt % or more and a size of maximum length of 5 mm or more (preferably, carbon dioxide hydrate) in accordance with the method described in the present specification may be employed. Alternatively, a method of preparing ice (preferably, carbon dioxide hydrate) previously produced may be employed. In view of convenience, it is preferable to use a method of preparing ice (preferably, carbon dioxide hydrate) previously produced.

It does not matter which of the above-mentioned Step A and Step B is carried out first, or these steps may be carried out at the same time.

The above-mentioned Step C in the preferable method for producing the alcoholic beverage of the present invention is not particularly limited as long as it is a step of adding the flavor improving agent of Step B in the alcoholic beverage prepared in Step A at the time of drinking the alcoholic beverage. A method for adding the flavor improving agent of Step B in the alcoholic beverage of Step A at the time of drinking the alcoholic beverage and preferable embodiment thereof are the same as in the method for adding the flavor improving agent of the present invention in a specific alcoholic beverage at the time of drinking the specific alcoholic beverage and its preferable embodiment.

3. <Method for Reducing Alcoholic Feeling and Improving Aroma Development while Suppressing Effervescence in the Alcoholic Beverage of the Present Invention>

The method for reducing alcoholic feeling and improving aroma development while suppressing effervescence in the alcoholic beverage of the present invention (hereinafter, also referred to as a “method of the present invention for reducing alcoholic feeling) is not particularly limited as long as the method includes adding the flavor improving agent of the present invention in a specific alcoholic beverage (the above-mentioned alcoholic beverage (a) or (b)) at the time of drinking the specific alcoholic beverage. By adding the flavor improving agent of the present invention in a specific alcoholic beverage at the time of drinking the specific alcoholic beverage, alcoholic feeling can be reduced and aroma development can be improved while suppressing effervescence in the alcoholic beverage.

As a preferable embodiment of the method of the present invention for reducing alcoholic feeling, a method comprising the following steps A to C can be exemplified.

(A) Step A of preparing the following alcoholic beverage (a) or (b):

(a) an alcoholic beverage having an alcohol content of 10% or more;

(b) an alcoholic beverage having an alcohol content of 4% or more and less than 10% and a total nitrogen content of 200 mg/L or less.

(B) Step B of preparing a flavor improving agent containing high CO₂-content ice (preferably, carbon dioxide hydrate) having a CO₂ content rate of 3 wt % or more and a size of maximum length of 5 mm or more;

(C) Step C of adding the flavor improving agent of Step B in the alcoholic beverage prepared in Step A at the time of drinking the alcoholic beverage.

The embodiment of a method for providing or producing the alcoholic beverage of the present invention and a preferable embodiment thereof can be applied as an embodiment of a method of the present invention for reducing alcoholic feeling and a preferable embodiment thereof.

In the present specification “effervescence is suppressed in an alcoholic beverage” means that “the degree of effervescence of an alcoholic beverage when the flavor improving agent of the present invention is added in the specific alcoholic beverage” is suppressed, compared to “the degree of effervescence of the same type and the same amount of alcoholic beverage, when a flavor improving agent (hereinafter, also referred to as a “control flavor improving agent”) having the same composition as the flavor improving agent of the present invention except that the high-CO₂ content ice (preferably, carbon dioxide hydrate) contained in the flavor improving agent has not a size of maximum length of 5 mm or more, but a size of less than 5 mm less is added in the same amount as the flavor improving agent of the present invention in the alcoholic beverage”. The degree of effervescence can be evaluated, for example, based on the expansion rate of an alcoholic beverage at the time of adding the flavor improving agent in the alcoholic beverage. In the present specification, “effervescence is suppressed in an alcoholic beverage” preferably include a case where the expansion rate of a specific alcoholic beverage when the flavor improving agent of the present invention is added is 0.9 times or less, preferably 0.8 times or less, more preferably 0.7 times or less and further preferably 0.6 times or less, relative to the expansion rate of the same type and the same amount of alcoholic beverage when any one of the control flavor improving agents is added. In the present specification, “effervescence is suppressed in an alcoholic beverage” includes, for example, a case where the expansion rate of a specific alcoholic beverage, in which the flavor improving agent of the present invention is added in an amount of 1 g/mL, 0.5 g/mL or 0.24 g/mL in terms of high CO₂-content ice (preferably, in terms of carbon dioxide hydrate), is 3 times or less. However, it is preferable to adjust the expansion rate so that the beverage or bubbles do not to spill over from the beverage container when the flavor improving agent of the present invention is added in an specific alcoholic beverage, in accordance with the content of the high-CO₂ content ice (preferably, carbon dioxide hydrate) in the flavor improving agent of the present invention; the CO₂ content rate of the high-CO₂ content ice (preferably, carbon dioxide hydrate); the degree of easiness of effervescence of a specific alcoholic beverage (e.g., low level of alcohol content, high level of total nitrogen content) and tolerance of a beverage container containing the specific alcoholic beverage to bubbles generated by addition of the high-CO₂ content ice (preferably, carbon dioxide hydrate).

In the present specification, “the expansion rate of an alcoholic beverage” refers to the ratio (times) of “the maximum of the volume of an alcoholic beverage (including bubbles of the beverage) after the flavor improving agent is added” relative to “the volume of the alcoholic beverage before the flavor improving agent is added”. The expansion rate in case when the a specific alcoholic beverage is an alcoholic beverage prepared by mixing two or more types of liquids, represents the expansion rate of the alcoholic beverage after mixing all of the liquids and adding the flavor improving agent. The expansion rate can be easily obtained by using a container having the equal sectional area from the bottom to the top, such as a cylindrical container, and dividing “the maximum height of the upper surface of bubbles of the beverage after the high-CO₂ content ice (preferably, carbon dioxide hydrate) is added” by “the height of the upper surface of the beverage before the high-CO₂ content ice (preferably, carbon dioxide hydrate) is added”.

In the present specification, the alcoholic beverage “reduced in alcoholic feeling” refers to a “specific alcoholic beverage in which the flavor improving agent of the present invention is added”, and an “alcoholic beverage reduced in alcoholic feeling compared to an alcoholic beverage prepared by adding the same amount of a control agent (hereinafter, also referred to as a “control agent”) having the same composition as the flavor improving agent of the present invention except that the high-CO₂ content ice (preferably, carbon dioxide hydrate) contained in the flavor improving agent is replaced by an ice consisting of the same amount of water as the water contained in the high-CO₂ content ice (preferably, carbon dioxide hydrate) to the same type and the same amount of alcoholic beverage”. Note that, for example, when the flavor improving agent of the present invention consists only of the high-CO₂ content ice (preferably, carbon dioxide hydrate), the control agent is an ice consisting of the same amount of water as the water contained in the high-CO₂ content ice (preferably, carbon dioxide hydrate). In the present specification, the “alcoholic feeling” is a taste sensed when a person drinks an alcoholic beverage and refers to bitter aftertaste and astringent taste derived from alcohol itself of the alcoholic beverage.

Whether alcoholic feeling of the “specific alcoholic beverage prepared by adding the flavor improving agent of the present invention” is reduced or not compared to the alcoholic feeling of the “alcoholic beverage prepared by adding a control agent in the same type and amount of alcoholic beverage” can be easily and clearly determined by a well-trained panelist.

In the present specification, the alcoholic beverage “improved in aroma development” refers to a “specific alcoholic beverage prepared by adding the flavor improving agent of the present invention” and an “alcoholic beverage improved in aroma development compared to an alcoholic beverage prepared by adding a control flavor improving agent or a control agent in the same type and the same amount of alcoholic beverage. In the present specification, “aroma development” refers to the intensity of intrinsic aroma of a specific alcoholic beverage, determined in the specific alcoholic beverage within 5 minutes, 3 minutes or one minute after the flavor improving agent of the present invention or a control flavor improving agent or control agent is added. The “intrinsic aroma of a specific alcoholic beverage”, which varies depending on, e.g., the type of alcoholic beverage and the raw material (including flavoring), refers to at least one of the intrinsic aromas of the alcoholic beverage which is not an aroma of alcohol itself. Examples of the intrinsic aroma of a specific alcoholic beverage include an aroma derived from a fruit used in wine (fruit wine) such as a fruity aroma in wine; an aroma derived from sub ingredients (fruit, herb, seed) used in liqueur, such as fresh aroma of cassis in cassis liqueur and fresh aroma of plum in plum wine; aroma of rice malt and brew aroma in rice shochu and aroma of aged whisky in a barrel and brew aroma of Japanese sake and aroma of aged Japanese sake.

Whether aroma development of the “specific alcoholic beverage prepared by adding the flavor improving agent of the present invention” is improved or not compared to the aroma development of the “alcoholic beverage prepared by adding a control flavor improving agent or control agent to the same type and amount alcoholic beverage” can be easily and clearly determined by a well-trained panelist.

Now, the present invention will be more specifically described by way of Examples below; however, the present invention is not limited by the Examples.

### Example 1

[Alcohol Content and Total Nitrogen Content of Alcoholic Beverage Used in Experiment]

In order to examine the effect of a particle size of a carbon dioxide hydrate when the carbon dioxide hydrate (hereinafter, also referred to simply as “hydrate”) having a CO₂ content rate of 3 wt % or more was added in an alcoholic beverage, the hydrate was added in various types of alcoholic beverages. The types, alcohol contents (%) and total nitrogen contents (mg/L) of the alcoholic beverages used in the experiment are as shown in Table 1. Note that, the alcoholic beverages listed in Table 1, beer and non-alcohol chu-hi do not correspond to the specific alcoholic beverage of the present invention; whereas other 7 types of alcoholic beverages correspond to the specific alcoholic beverage of the present invention.

TABLE 1

| | Alcohol | Total content of nitrogen |
|---|---|---|
| Type of alcoholic beverage | content (%) | compound (mg/L) |
| White wine (grape wine) | 11.5 | 537 |
| Cassis liqueur | 20.0 | 169 |
| Whisky | 50.0 | ≤31 |
| Shochu | 25.0 | ≤31 |
| Plum wine | 10.0 | 32 |
| Spirits sparkling (1) | 9.0 | ≤31 |
| (relatively high alcohol content) | | |
| Spirits sparkling (1) | 4.0 | About 32 |
| (relatively low alcohol content) | | |
| Beer | 5.0 | 600 to 800 |
| Non-alcohol chu-hi | 0.0 | About 32 |

The alcoholic beverages listed in Table 1 are all commercially available. The alcohol contents of these alcoholic beverages are those displayed on the containers of individual commercially available beverages. The total nitrogen contents of individual alcoholic beverages were measured by a combustion method using SUMIGRAPH NCH-22F manufactured by Sumika Chemical Analysis Service, Ltd.

### Example 2

[Preparation of Hydrate]

Two types of hydrates to be added in various alcoholic beverages were prepared in accordance with the following method.

(1) Preparation of Hydrate Having a Particle Size of 5 Mm or More

To 4 L of water, CO₂ gas was blown in so as to obtain 3 MPa. A hydrate formation reaction was allowed to proceed at 1° C. while stirring. Thereafter, the mixture was cooled down to −20° C. Polyhedral hydrate having a maximum length of 5 mm or more and 60 mm or less was selectively collected and used in experiments later described. The aspect ratio (maximum length/minimum length) of these hydrates was about 1 to 4. Note that the CO₂ content rate of these hydrates was 12 to 18%.

(2) Preparation of Hydrate Having a Particle Size of Less than 5 mm

To 4 L of water, CO₂ gas was blown in so as to obtain 3 MPa. A hydrate formation reaction was allowed to proceed at 1° C. while stirring. Thereafter, the mixture was cooled down to −20° C. and hydrate were collected and crushed. The hydrate particles having a maximum length of less than 5 mm were selectively collected and used in experiments later described. Note that the CO₂ content rate of these hydrate particles was 12 to 18%.

### Example 3

[Effect of Size of Hydrate on Expansion Rate and Effervescence of Beverage Prepared by Adding Hydrate in Alcoholic Beverage]

The effect of hydrate particle size on the expansion rate and effervescence of a beverage prepared by adding hydrate in alcoholic beverage was examined by the following experiment.

In beverage containers with the top opened, individual alcoholic beverages listed in Table 1 were poured, and then, hydrates prepared in the above Example 2 were added. The expansion rates (times) of the resultant alcoholic beverages were measured. The amounts of hydrate added and expansion rates are shown in Table 2. Note that, the expansion rate of an alcoholic beverage refers to the ratio (times) of “the volume of an alcoholic beverage (including bubbles of the beverage) after a hydrate is added” relative to “the volume of the alcoholic beverage before the hydrate is added. Whether effervescence is suppressed or not was evaluated as follows. If the expansion rate is less than 3, the case was rated as (“∘”) and determined that effervescence is suppressed; whereas if the expansion rate exceeds 3, the case was rated as (“x”) and determined that effervescence is not suppressed. The results of effervescence suppression are also shown in Table 2.

TABLE 2

| | Hydrate of ≥5 mm in maximum length | | | Hydrate of <5 mm in maximum length | | |
|---|---|---|---|---|---|---|
| Type of alcoholic | Addition | Expansion | Suppression of | Addition | Expansion | Suppression of |
| beverage | amount | rate | effervescence | amount | rate | effervescence |
| White wine | 11.8 g/50 mL | 1.8 times | ∘ | 6.1 g/50 mL | 3.4 times | x |
| (cooled) | | | | | | |
| Cassis liqueur | 10 g/20 mL | 2.5 times | ∘ | 10 g/20 mL | ≥5 times | x |
| (normal | | | | | | |
| temperature) | | | | | | |
| Whisky | 20 g/20 mL | 2 times | ∘ | 20 g/20 mL | 4.8 times | x |
| (normal | | | | | | |
| temperature) | | | | | | |
| Shochu (normal | 20 g/20 mL | 2.4 times | ∘ | 20 g/20 mL | 4.8 times | x |
| temperature) | | | | | | |
| Plum wine | 10 g/20 mL | 1.9 times | ∘ | 10 g/20 mL | ≥5 times | x |
| (normal | | | | | | |
| temperature) | | | | | | |
| Spirits sparkling | 10 g/20 mL | 2.5 times | ∘ | 10 g/20 mL | ≥5 times | x |
| (1) | | | | | | |
| (relatively high | | | | | | |
| alcohol content) | | | | | | |
| (cooled) | | | | | | |
| Spirits sparkling | 10 g/20 mL | 2.7 times | ∘ | 10 g/20 mL | ≥5 times | x |
| (1) | | | | | | |
| (relatively low | | | | | | |
| alcohol content) | | | | | | |
| (cooled) | | | | | | |
| Beer | 3.1 g/50 mL | 4.8 times | x | — | — | — |
| (normal | | | | | | |
| temperature) | | | | | | |
| Beer | 4.0 g/50 mL | 5.2 times | x | — | — | — |
| (cooled) | | | | | | |
| Non-alcohol chu- | 10 g/50 mL | 4 times | x | — | — | — |
| hi | | | | | | |
| (cooled) | | | | | | |

As is apparent from the results of Table 2 referring to Table 1, in alcoholic beverages except beer and non-alcohol chu-hi, the expansion rate was 2.7 times or less and effervescence of the beverages was successfully suppressed, when a hydrate having a maximum length of 5 mm or more was added; however, the expansion rate was 3.4 times or more and effervescence of the beverages was not suppressed when hydrate having a maximum length of less than 5 mm was added. Note that, in Table 2, in alcoholic beverages except white wine, the amount of a hydrate having a maximum length of 5 mm or more added is equal to the amount of a hydrate having a maximum length of less than 5 mm added. In contrast, in the case of white wine, even though the amount of a hydrate having a maximum length of less than 5 mm added was set to be about half as low as that of the hydrate having a maximum length of 5 mm or more, the expansion rate was as high as 3.4 times.

In the cases of beers and non-alcohol chu-hi, even though the amount of the hydrate having a maximum length of 5 mm or more added was set to be equal to or lower than the amounts added in other alcoholic beverages, the expansion rates were 4 times or more and effervescence of the beverages was not suppressed. In the case of spirits sparkling (1) (relatively low alcohol content) (alcohol content: 4.0%, total nitrogen content: about 32 mg/L), effervescence of the beverages was suppressed; whereas, in beer (alcohol content: 5.0%, total nitrogen content: 600 to 800 mg/L), effervescence of the beverages was not suppressed. This is considered because the total nitrogen content which is an index of the protein concentration thereof is high in beers, in other words, the concentration of a substance being the factor of making bubbles was high; whereas, in spirits sparkling (1) (relatively low alcohol content), the total nitrogen content was low, and the concentration of a substance being the factor of making bubbles was low. In beer (alcohol content: 5.0%, total nitrogen content: 600 to 800 mg/L), effervescence of the beverage was not suppressed when a hydrate having a maximum length of 5 mm or more was added; whereas in white wine (alcohol content: 11.5%, total nitrogen content: 537 mg/L), effervescence was suppressed. This is considered because it was difficult to make bubbles in white wine because the alcohol content is higher than beer.

From the results of Table 1 and Table 2, it was found that when the hydrate having a maximum length of 5 mm or more is added in a beverage, compared to the hydrate having a maximum length of less than 5 mm, remarkably low expansion rate of the beverage is resulted, and it has been shown that the hydrate having a maximum length of 5 mm or more is effective in suppressing effervescence. It has been shown that as the alcoholic beverage which effervescence is suppressed when the hydrate having a maximum length of 5 mm or more was added, an “alcoholic beverage having a high alcohol content (for example, 10% or more)” and an “alcoholic beverage having a moderate alcohol content (for example, 4% or more and less than 10%) and a low total nitrogen content (for example, 200 mg/L or less)” can be preferably exemplified. Note that, a preferable amount of hydrate having a maximum length of 5 mm or more added can be appropriately adjusted by those skilled in the art with reference to types of alcoholic beverages, amounts of hydrate added and expansion rates shown in Table 2.

Note that test samples (specific alcoholic beverages to which a hydrate having a maximum length of 5 mm or more was added) shown in Table 2 and comparative test samples (specific alcoholic beverages to which a hydrate having a maximum length of less than 5 mm was added) shown in Table 2 were evaluated on flavor by sensory assessment by three experts (panelists) one minute after the hydrate was added in individual samples. As a result, in the test samples (specific alcoholic beverages to which a hydrate having a maximum length of 5 mm or more was added), aroma development of an intrinsic aroma of the specific alcoholic beverages was improved, as is shown in Table 4 in Example 4 and Table 6 in Example 5. In contrast, in the comparative test samples (specific alcoholic beverages to which a hydrate having a maximum length of less than 5 mm was added) shown in Table 2, effervescence was not suppressed as well as smell of carbon dioxide gas was strongly sensed, with the result that the aroma development of an intrinsic aroma of specific alcoholic beverages rather decreased.

### Example 4

[Effect (1) of Hydrate on the Flavor of Beverage at the Time of Adding Hydrate in Alcoholic Beverage]

In order to examine the effects of a hydrate added in an alcoholic beverage on flavor of the alcoholic beverage, the following experiments were carried out.

In test samples, hydrate having a particle size of 5 mm or more and 60 mm or less (CO₂ content rate: 12 to 18%) and produced in the above Example 2 (1) were used as a hydrate. In comparative test samples, commercially available conventional ice (rock ice) was employed as a control.

Sixteen types of sample beverages listed in the following Table 3 were prepared in accordance with the blending ratios shown in Table 3. Note that, when highball was prepared, “hydrate” or “water” was added after air bubbles generated from the added carbonated water has calmed down.

TABLE 3

| | Type of | Alcohol | |
|---|---|---|---|
| | beverage | content | Blending ratio |
| Test sample 1 | White wine | 11.5 | Hydrate:White wine = 10 g:20 |
| | | | mL |
| Comparative | White wine | 11.5 | Ice:White wine = 10 g:20 mL |
| test sample 1 | | | |
| Test sample 2 | Cassis liqueur | 20.0 | Hydrate:Cassis liqueur = 10 |
| | | | g:20 mL |
| Comparative | Cassis liqueur | 20.0 | Ice:Cassis liqueur = 10 g:20 |
| test sample 2 | | | mL |
| Test sample 3 | Whisky (rock) | 50.0 | Hydrate:Whisky = 20 g:20 |
| | | | mL |
| Comparative | Whisky (rock) | 50.0 | Ice:Whisky = 20 g:20 mL |
| test sample 3 | | | |
| Test sample 4 | Whisky (high- | 10.0 | Hydrate:Ice:Carbonated |
| | ball) | | water:Whisky = 20 g:20 g:40 |
| | | | mL:10 mL |
| Comparative | Whisky (high- | 10.0 | Ice:Carbonated water:Whis- |
| test sample 4 | ball) | | ky = 40 g:40 mL:10 mL |
| Test sample 5 | Rice shochu | 25.0 | Hydrate:Rice shochu = 20 |
| | | | g:20 mL |
| Comparative | Rice shochu | 25.0 | Ice:Rice shochu = 20 g:20 mL |
| test sample 5 | | | |
| Test sample 6 | Plum wine | 10.0 | Hydrate:Plum wine = 10 g:20 |
| | | | mL |
| Comparative | Plum wine | 10.0 | Ice:Plum wine = 10 g:20 mL |
| test sample 6 | | | |
| Test sample 7 | Spirits | 9.0 | Hydrate:Spirits = 10 g:20 mL |
| | sparkling (1) | | |
| | (relatively high | | |
| | alcohol con- | | |
| | tent) | | |
| Comparative | Spirits | 9.0 | Ice:Spirits = 10 g:20 mL |
| test sample 7 | sparkling (1) | | |
| | (relatively high | | |
| | alcohol con- | | |
| | tent) | | |
| Test sample 8 | Spirits | 4.0 | Hydrate:Spirits = 10 g:20 mL |
| | sparkling (1) | | |
| | (relatively low | | |
| | alcohol con- | | |
| | tent) | | |
| Comparative | Spirits | 4.0 | Ice:Spirits = 10 g:20 mL |
| test sample 8 | sparkling (1) | | |
| | (relatively low | | |
| | alcohol con- | | |
| | tent) | | |

One minute after addition of a hydrate or ice to individual sample beverages, individual sample beverages were evaluated on flavor by sensory assessment by three experts (panelists). The results are shown in Table 4.

TABLE 4

| | | Flavor change compared to the |
|---|---|---|
| | Type of | corresponding Comparative test |
| | beverage | sample |
| Test sample 1 | White wine | Reduced in alcoholic feeling |
| | | Improved in development of fruity |
| | | aroma intrinsic to white wine |
| Comparative test | White wine | |
| sample 1 | | |
| Test sample 2 | Cassis liqueur | Reduced in alcoholic feeling |
| | | Improved in development of fresh |
| | | fruit aroma intrinsic to cassis |
| | | liqueur |
| Comparative test | Cassis liqueur | |
| sample 2 | | |
| Test sample 3 | Whisky (rock) | Reduced in alcoholic feeling |
| | | Improved in development of aroma |
| | | intrinsic to aged whisky in barrel |
| Comparative test | Whisky (rock) | |
| sample 3 | | |
| Test sample 4 | Whisky (highball) | Reduced in alcoholic feeling |
| | | Improved in development of aroma |
| | | intrinsic to aged whisky in barrel |
| Comparative test | Whisky (highball) | |
| sample 4 | | |
| Test sample 5 | Rice shochu | Reduced in alcoholic feeling |
| | | Improved in development of brew |
| | | aroma intrinsic to rice shochu |
| Comparative test | Rice shochu | |
| sample 5 | | |
| Test sample 6 | Plum wine | Reduced in alcoholic feeling |
| | | Improved in development of fresh |
| | | plum aroma intrinsic to plum wine |
| Comparative test | Plum wine | |
| sample 6 | | |
| Test sample 7 | Spirits sparkling | Reduced in alcoholic feeling |
| | (1) (relatively | Improved in development of fresh |
| | high alcohol | fruit aroma intrinsic to spirits |
| | content) | |
| Comparative test | Spirits sparkling | |
| sample 7 | (1) (relatively | |
| | high alcohol | |
| | content) | |
| Test sample 8 | Spirits sparkling | Reduced in alcoholic feeling |
| | (1) (relatively | Improved in development of fruity |
| | low alcohol | aroma intrinsic to spirits |
| | content) | |
| Comparative test | Spirits sparkling | |
| sample 8 | (1) (relatively | |
| | low alcohol | |
| | content) | |

As is apparent from the results of Table 4, it was demonstrated that if a hydrate (a particle size of 5 mm or more and 60 mm or less) is added in specific alcoholic beverages (e.g., distilled liquor and high alcohol content beverage), compared to the cases of adding the same amount of ice, alcohol stimulation (alcoholic feeling) is reduced; at the same time, aroma development of an intrinsic aroma of the alcoholic beverages is improved.

### Example 5

[Effect (2) of Hydrate on the Flavor of Beverage at the Time of Adding Hydrate in Alcoholic Beverage]

In the experiment of the above Example 4, it was demonstrated that if a hydrate (a particle size of 5 mm or more and 60 mm or less) is added in specific alcoholic beverages (e.g., distilled liquor and high alcohol content beverage), compared to the cases of adding the same amount of ice, alcohol stimulation (alcoholic feeling) is reduced; at the same time, aroma development of an intrinsic aroma of the alcoholic beverages is improved. Then, ice having a low CO₂ content rate (hereinafter, referred to as “low carbonate ice”) serving as a control was used and the effect of the ice on flavor of the beverages was compared to those of a hydrate.

As the hydrate, a hydrate (a particle size of 5 mm or more and 60 mm or less (CO₂ content rate 17.6%)) prepared in the above Example 2 (1) was used. The low carbonate ice was prepared by blowing CO₂ gas in water (4 L) so as to obtain 1.5 MPa, dissolving CO₂ at 20° C. and thereafter cooling the mixture down to −20° C. The particle size of low carbonate ice was specified to be substantially the same as that of the hydrate (5 mm or more and 60 mm or less). The CO₂ content rate of the low carbonate ice was 0.4 to 2.6% and 1.2% in average.

Six types of alcoholic beverages sample listed in the following Table 5 were prepared in accordance with the blending ratios shown in Table 5. Note that, as the “ice” used in whisky (highball), commercially available rock ice was used. When whisky (highball) is prepared, “hydrate” or “water” was added after air bubbles generated from the added carbonated water has calmed down.

TABLE 5

| | | Alcohol | |
|---|---|---|---|
| | Type of | content | |
| | beverage | (%) | Blending ratio |
| Test sample 9 | Whisky (rock) | 50.0 | Hydrate:Whisky = 10 g:10 |
| | | | mL |
| Comparative | Whisky (rock) | 50.0 | Low carbonate ice:Whisky = |
| test sample 9 | | | 10 g:10 mL |
| Test sample 10 | Whisky (high- | 10.0 | Hydrate:Water:Carbonated |
| | ball) | | water:Whisky = 20 g:20 g:40 |
| | | | mL:10 mL |
| Comparative | Whisky (high- | 10.0 | Low carbonate ice:Ice:Car- |
| test sample 10 | ball) | | bonated water:Whisky = 20 |
| | | | g:20 g:40 mL:10 mL |
| Test sample 11 | Rice shochu | 25.0 | Hydrate:Rice shochu = 10 |
| | | | g:10 mL |
| Comparative | Rice shochu | 25.0 | Low carbonate ice:Rice |
| test sample 11 | | | shochu = 10 g:10 mL |

One minute after addition of a hydrate or low carbonate ice to individual sample beverages, individual sample beverages were evaluated on flavor by sensory assessment by three experts (panelists). The results are shown in Table 6.

TABLE 6

| | Type of beverage | Flavor change, easiness to drink |
|---|---|---|
| Test sample 9 | Whisky (rock) | Creamy mild taste and reduction of alcoholic feeling are sensed. |
| | | Initial aroma development is strong. Intrinsic aroma of aged |
| | | whisky in barrel is strong. |
| | | Since effervescence of the beverage and breakage of hydrate are |
| | | not seen, beverage is easy to drink. |
| Comparative test | Whisky (rock) | Carbonate (fizziness) is slightly sensed; however, reduction of |
| sample 9 | | alcoholic feeling is not sensed. |
| | | Flavor is substantially the same as in conventional ice. |
| | | Since hydrate is broken during drinking, beverage is not easy to |
| | | drink. |
| Test sample 10 | Whisky (highball) | Carbonate (fizziness) is strong (acquired 8 out of 10 points in |
| | | evaluation), Creamy mild taste and reduction of alcoholic feeling |
| | | are sensed. |
| | | Intrinsic aroma of aged whisky in barrel is strongly sensed. |
| | | Since effervescence of the beverage and breakage of hydrate are |
| | | not seen, beverage is easy to drink. |
| Comparative test | Whisky (highball) | Carbonate (fizziness) (acquired 3 out of 10), which is |
| sample 10 | | substantially the same as in conventional ice (2 out of 10). |
| | | Reduction of alcoholic feeling is not sensed. |
| | | Flavor is substantially the same in conventional ice. |
| | | Since low carbonate ice is broken during drinking, beverage is |
| | | not easy to drink. |
| Test sample 11 | Rice shochu | Creamy mild taste and reduction of alcoholic feeling are sensed. |
| | | Initial aroma development is strong. Intrinsic aroma of rice |
| | | shochu is strongly sensed. |
| | | Since effervescence of the beverage and breakage of hydrate are |
| | | not seen, beverage is easy to drink. |
| Comparative test | Rice shochu | Slight carbonate (fizziness) is sensed; however, reduction of |
| sample 11 | | alcoholic feeling is not sensed. |
| | | Flavor is substantially the same as in conventional ice. |
| | | Since hydrate is broken during drinking, beverage is not easy to |
| | | drink. |

As is apparent from the results of Table 6, it was demonstrated that even though low carbonate ice is added, alcoholic feeling cannot be reduced and aroma development of an intrinsic aroma of the alcoholic beverages is not improved. In other words, it was demonstrated that if a carbon dioxide hydrate having a maximum length of 5 mm or more having a CO₂ content rate of 3 wt % or more is added in a specific alcoholic beverage, it can produce remarkable effects of reducing alcoholic feeling of the alcoholic beverage and improving aroma development of an intrinsic aroma of the alcoholic beverage. It is also demonstrated that if low carbonate ice is added in a specific alcoholic beverage, since low carbonate ice is broken during drinking, the beverage is not easy to drink; whereas, if the hydrate of the present invention is added, the hydrate is not broken and the beverage is easy to drink.

### INDUSTRIAL APPLICABILITY

According to the present invention, “a flavor improving agent for reducing alcoholic feeling and improving aroma development in a specific alcoholic beverage at the time of drinking the specific alcoholic beverage” and “a method for providing or producing an alcoholic beverage reduced in alcoholic feeling and improved in aroma development while suppressing effervescence by adding the flavor improving agent in the specific alcoholic beverage at the time of drinking the specific alcoholic beverage, etc., can be provided.

1.-6. (canceled)

7. A method for producing an alcoholic beverage having reduced alcoholic feeling and improved aroma development, and suppressed effervescence, comprising adding ice having a size of maximum length of 5 mm or more and a CO₂ content rate of 3 wt % or more in the following alcoholic beverage (a) or (b) at the time of drinking the alcoholic beverage, thereby reducing alcoholic feeling and improving aroma development while suppressing effervescence in the alcoholic beverage:
(a) an alcoholic beverage having an alcohol content of 10% or more;
(b) an alcoholic beverage having an alcohol content of 4% or more and less than 10% and a total nitrogen content of 200 mg/L or less.

8. The method according to claim 7, wherein the ice is a carbon dioxide hydrate.

9. The method according to claim 7, wherein the alcoholic beverage is selected from the group consisting of fruit liquors, distilled liquors, liqueurs and Japanese sake.

10. The method according to claim 8, wherein the alcoholic beverage is selected from the group consisting of fruit liquors, distilled liquors, liqueurs and Japanese sake.

11. The method according to claim 7, wherein the amount of the ice to be added in the alcoholic beverage is within the range of 0.02 to 4.0 g/mL.

12. The method according to claim 8, wherein the amount of the carbon dioxide hydrate to be added in the alcoholic beverage is within the range of 0.02 to 4.0 g/mL.

13. The method according to claim 9, wherein the amount of the ice to be added in the alcoholic beverage is within the range of 0.02 to 4.0 g/mL.

14. The method according to claim 10, wherein the amount of the carbon dioxide hydrate to be added in the alcoholic beverage is within the range of 0.02 to 4.0 g/mL.

15. A method of reducing alcoholic feeling and improving aroma development while suppressing effervescence in an alcoholic beverage, comprising adding ice having a size of maximum length of 5 mm or more and a CO₂ content rate of 3 wt % or more in the following alcoholic beverage (a) or (b) at the time of drinking the alcoholic beverage:
(a) an alcoholic beverage having an alcohol content of 10% or more;
(b) an alcoholic beverage having an alcohol content of 4% or more and less than 10% and a total nitrogen content of 200 mg/L or less.

16. The method according to claim 15, wherein the ice is a carbon dioxide hydrate.

17. The method according to claim 15, wherein the alcoholic beverage is selected from the group consisting of fruit liquors, distilled liquors, liqueurs and Japanese sake.

18. The method according to claim 16, wherein the alcoholic beverage is selected from the group consisting of fruit liquors, distilled liquors, liqueurs and Japanese sake.

19. The method according to claim 15, wherein the amount of the ice to be added in the alcoholic beverage is within the range of 0.02 to 4.0 g/mL.

20. The method according to claim 16, wherein the amount of the carbon dioxide hydrate to be added in the alcoholic beverage is within the range of 0.02 to 4.0 g/mL.

21. The method according to claim 17, wherein the amount of the ice to be added in the alcoholic beverage is within the range of 0.02 to 4.0 g/mL.

22. The method according to claim 18, wherein the amount of the carbon dioxide hydrate to be added in the alcoholic beverage is within the range of 0.02 to 4.0 g/mL.

23. A flavor improving agent for reducing alcoholic feeling and improving aroma development in the following alcoholic beverage (a) or (b) at the time of drinking the alcoholic beverage, wherein the flavor improving agent comprises ice having a size of maximum length of 5 mm or more and a CO₂ content rate of 3 wt % or more:
(a) an alcoholic beverage having an alcohol content of 10% or more;
(b) an alcoholic beverage having an alcohol content of 4% or more and less than 10% and a total nitrogen content of 200 mg/L or less.

24. The flavor improving agent according to claim 23, wherein the ice having a CO₂ content rate of 3 wt % or more is a carbon dioxide hydrate.

25. The flavor improving agent according to claim 23, wherein the alcoholic beverage is selected from the group consisting of fruit liquors, distilled liquors, liqueurs and Japanese sake.

26. The flavor improving agent according to claim 24, wherein the alcoholic beverage is selected from the group consisting of fruit liquors, distilled liquors, liqueurs and Japanese sake.
